(19) United States
(12) Patent Application Publication
(10) Pub. No.: US 2020/0079183 A1
(43) Pub. Date: Mar. 12, 2020

(54) HEAT EXCHANGER

(71) Applicant: DENSO International America, Inc., Southfield, MI (US)

(72) Inventors: Parker FARLOW, Warren, MI (US); Aaron VANDIVER, Ferndale, MI (US)

(21) Appl. No.: 16/123,391

(22) Filed: Sep. 6, 2018

(51) Int. Cl. B60H 1/32; B60H 1/00; F16F 13/20; F16F 13/26; F16F 13/10

(52) U.S. Cl. CPC B60H 1/3208; B60H 1/3227; F16F 13/106; F16F 13/20; F16F 13/264; B60H 1/00899

(57) ABSTRACT

A heat exchanger for a vehicle is disposed in a fluid circuit in which a fluid is circulated according to an operating condition of the vehicle. The heat exchanger includes a tank and a pressure adjuster. The tank defines a tank chamber therein and is configured to allow the fluid to flow through the tank chamber. The pressure adjuster is disposed inside the tank and defines a damper chamber separately from the tank chamber. The pressure adjuster is configured to be displaceable or deformable to expand and reduce the damper chamber. The damper chamber is filled with a compressible gas. The pressure adjuster is configured to reduce the damper chamber in response to an increase in a pressure of the fluid in the tank chamber. The pressure adjuster is configured to expand the damper chamber in response to a decrease in a pressure of the fluid in the tank chamber.

### TECHNICAL FIELD

The present disclosure relates to a heat exchanger.

### BACKGROUND

Heat exchangers, such as those mounted in vehicles, may include a tank defining a tank chamber therein. Generally, such heat exchangers are disposed in fluid circuits in which fluid is circulated according to an operating condition of the vehicles.

### SUMMARY

This section provides a general summary of the disclosure, and is not a comprehensive disclosure of its full scope or all of its features.

An aspect of the present disclosure provides a heat exchanger for a vehicle disposed in a fluid circuit in which a fluid is circulated according to an operating condition of the vehicle. The heat exchanger includes a tank and a pressure adjuster. The tank defines a tank chamber therein and is configured to allow the fluid to flow through the tank chamber. The pressure adjuster is disposed inside the tank and defines a damper chamber separately from the tank chamber. The pressure adjuster is configured to be displaceable or deformable to expand and reduce the damper chamber. The damper chamber is filled with a compressible gas. The pressure adjuster is configured to reduce the damper chamber in response to an increase in a pressure of the fluid in the tank chamber. The pressure adjuster is configured to expand the damper chamber in response to a decrease in a pressure of the fluid in the tank chamber.

Another aspect of the present disclosure provides a heat exchanger for a vehicle disposed in a fluid circuit in which a fluid is circulated according to an operating condition of the vehicle. The heat exchanger includes a tank and a pressure adjuster. The tank defines a tank chamber therein and is configured to allow the fluid to flow through the tank chamber. The pressure adjuster is disposed outside the tank and defines a damper chamber. The damper chamber is in fluid communication with the tank chamber to receive the fluid. The pressure adjuster is configured to be displaceable or deformable to expand and reduce the damper chamber. The pressure adjuster is configured to expand the damper chamber in response to an increase in a pressure of the fluid in the tank chamber. The pressure adjuster is configured to reduce the damper chamber in response to a decrease in a pressure of the fluid in the tank chamber.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic diagram showing fluid circuits of a vehicle.

FIG. 2 is a schematic diagram showing a heat exchanger in at least one embodiment of the present disclosure.

FIG. 3 is a diagram showing a pressure damper in at least one embodiment of the present disclosure.

FIG. 4 is a graph showing a tank pressure profile in a tank of the heat exchanger in a comparative example without the pressure adjuster.

FIG. 5 is a graph showing a tank pressure profile in the tank of the heat exchanger in at least one embodiment of the present disclosure with the pressure adjuster.

FIG. 6 is a diagram showing a pressure damper in at least one embodiment of the present disclosure.

FIG. 7 is a diagram showing a modification example of the pressure damper shown in FIG. 6.

FIG. 8 is a diagram showing a pressure damper in at least one embodiment of the present disclosure.

FIG. 9 is a diagram showing a pressure damper in at least one embodiment of the present disclosure.

FIG. 10 is a diagram enlarging a portion circled by a dashed line in FIG. 9 and showing a structure connecting the pressure damper to the tank shown in FIG. 9.

FIG. 11 is a diagram showing a pressure damper in at least one embodiment of the present disclosure.

FIG. 12 is an enlarged view of a portion circled by a dashed line in FIG. 11.

FIG. 13 is an enlarged view of the portion circled by the dashed line in FIG. 11.

### DETAILED DESCRIPTION

### First Embodiment

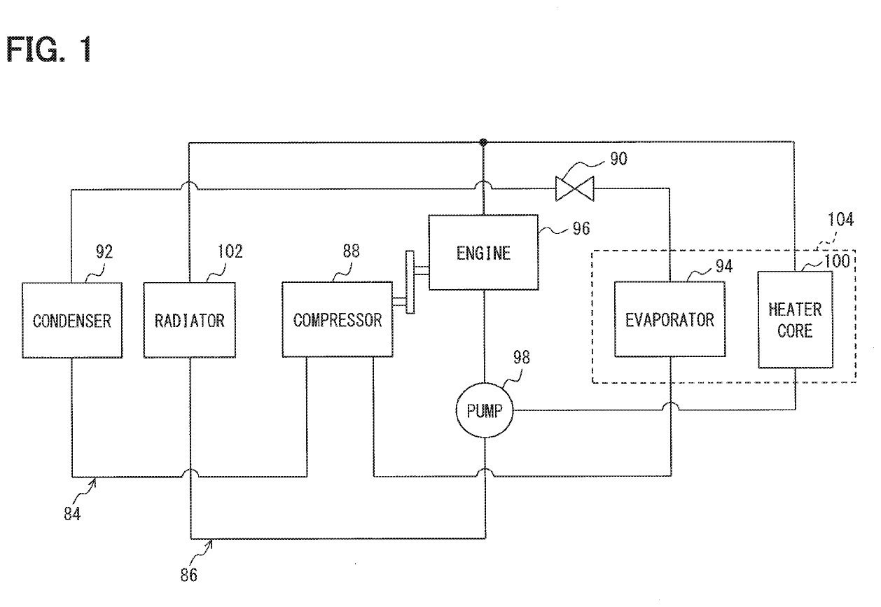

A first embodiment is described with reference to FIG. 1 to FIG. 5.

FIG. 1 shows an example configuration of fluid circuits of a vehicle in which fluid circulates according to an operation of the vehicle. For example, the fluid circuits may include a refrigeration circuit 84 and an engine cooling circuit 86. The refrigeration circuit 84 allows fluid to circulate to perform heat exchange as a refrigerant. The engine cooling circuit 86 allows fluid to circulate to perform heat exchange as a coolant (e.g., engine cooling water).

Each fluid circuit includes various heat exchangers and various components that are fluidly connected to each other. For example, the refrigeration circuit 84 may include a compressor 88, an expansion valve 90, and heat exchangers such as a condenser 92 and an evaporator 94. The engine cooling circuit 86 may include an internal combustion engine (hereinafter referred to as an engine 96), a pump 98, and heat exchangers such as a heater core 100 and a radiator 102.

The evaporator 94 of the refrigeration circuit 84 and the heater core 100 configure an HVAC unit 104 for a vehicle. The HVAC unit 104 is configured to perform air conditioning of a vehicle compartment by using heat of the fluid (or the refrigerant) circulating in the refrigeration circuit 84 and the fluid (or the coolant) circulating in the engine cooling circuit 86.

Here, the temperature and pressure in the fluids vary while exchanging heat. As such, internal pressures of the fluid circuits vary according to the change in the temperature and pressure of the fluids. Such a fluctuation may cause stress in heat exchangers continuously, resulting in damaging the heat exchangers.

The fluctuation of the internal pressures may more often occur in a fluid circuit having a pump that changes a flow rate of the fluid according to operating conditions of the vehicle.

In an example shown in FIG. 1, operation of the pump 98 is linked to operating conditions of the engine 96 and therefore a pump speed is dependent upon an engine speed. For instance, when the engine speed is high, the pump is controlled to operate with a high speed. In contrast, when the engine speed is low, the pump is controlled at a low speed. The acceleration and the deceleration of the engine 96 may be repeated frequently in response to a change of the operating condition of the vehicle. As such, the pump speed may be changed frequently, and therefore causing a fluctuation of internal pressure in the fluid circuit.

To address this issue, a heat exchanger 12 in the present embodiment includes a structure to alleviate fatigue of the components. The heat exchanger 12 may be any one of the condenser 92, the evaporator 94, the heater core 100, and the radiator 102. The heat exchanger 12 may reduce the fluctuation of the internal pressure substantially when the heat exchanger 12 is the heater core 100 or the radiator 102 that is directly connected to the pump 98 in the engine cooling circuit 86. For description purpose, the heat exchanger 12 will be described as the radiator 102 hereinafter. However, as described above, it should be understood that the heat exchanger 12 is not limited to be the radiator 102.

A structure of the heat exchanger 12 will be described hereafter in greater detail.

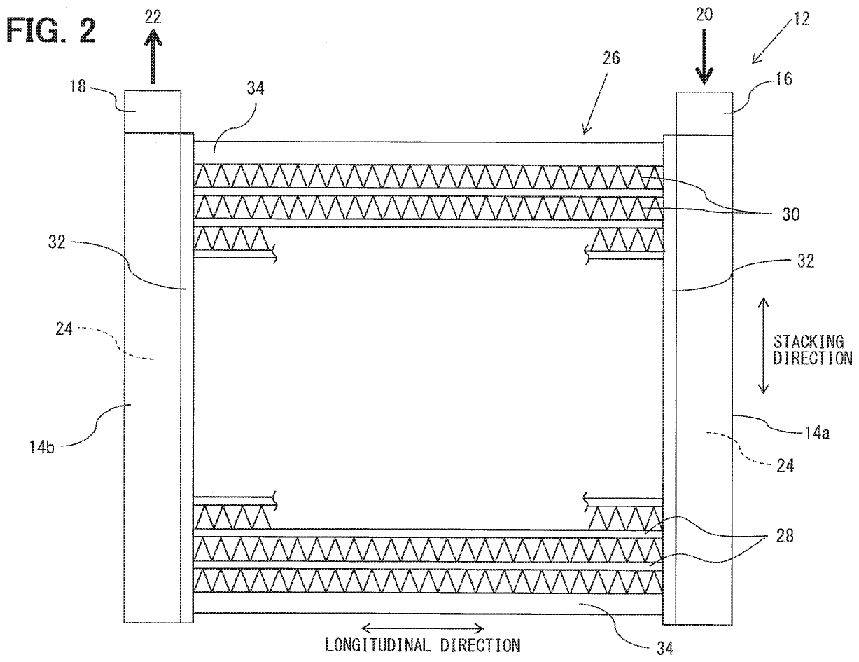

As shown in FIG. 2, the heat exchanger 12 includes two tanks 14a, 14b, a core 26, and two side plates 34. The two tanks 14, the core 26, and the two side plates 34 may be assembled integrally with each other to form the heat exchanger 12. For example, the two tanks 14, the two core plates 32, and the two side plates 34 may be fixed to one another into one component, e.g., through brazing, welding, or mechanical fasteners.

The core 26 includes a plurality of tubes 28 and two core plates 32. The tubes 28 are stacked along a stacking direction (see FIG. 2). The tubes 28 extend along a longitudinal direction to be parallel with each other, and fluid is allowed to flow through the tubes 28. The core 26 may further include a plurality of fins 30. The tubes 28 and the fins 30 may be stacked alternately along the stacking direction, which is perpendicular to the longitudinal direction, and may be integrally fixed to each other, e.g., through brazing, welding, or mechanical fasteners. The fins 30 each are formed in a wave form (i.e., a corrugated form) and extend along the longitudinal direction to be parallel with each other.

Each side plate 34 is positioned on one side of the core 26 so that the two side plates 34 are opposite to each other in the stacking direction. The side plates 34 are provided to mechanically reinforce the core 26.

The two tanks 14a, 14b and the two core plates 32 are disposed on two opposing sides of the core 26 in the longitudinal direction, i.e., such that the core 26 is interposed between the tanks 14a, 14b and the core plates 32 in the longitudinal direction. Each tank 14a, 14b is coupled with the corresponding core plate 32 and defines a tank chamber 24a, 24b therein together with the core plate 32.

The two tanks 14a, 14b may have the same configuration. For explanation purpose, the one tank 14a will be referred to as an inlet tank 14a having an inlet port 16 and the other tank 14b will be referred to as an outlet tank 14b having an outlet port 18. It should be understood that the one tank 14a may be an outlet tank and the other tank 14b may be the inlet tank since the tanks 14a and 14b have the same configuration.

Fluid flows into the inlet tank 14a, flows through the core 26, and flows out from the outlet tank 14b. Specifically, the inlet tank 14a and the outlet tank 14b may be further connected to other components in the fluid circuit, i.e., a heat exchange system. For example, the heat exchanger 12 is described as the radiator 102 in the present embodiment. As such, the inlet tank 14a may be fluidly connected to the engine 96 via any suitable pipe means, and the outlet tank 14b may be connected to the pump 98 via any suitable pipe means.

The fluid flows into the inlet tank 14a from the inlet port 16 as shown by the arrow 20, and flows out of the outlet tank 14b from the outlet port 18 as shown by the arrow 22, for example, as shown in FIG. 2.

To reduce the fluctuation of the internal pressure, the heat exchanger 12 includes a pressure adjuster 25 to alleviate fatigue of components of the heat exchanger 12 such as the core 26.

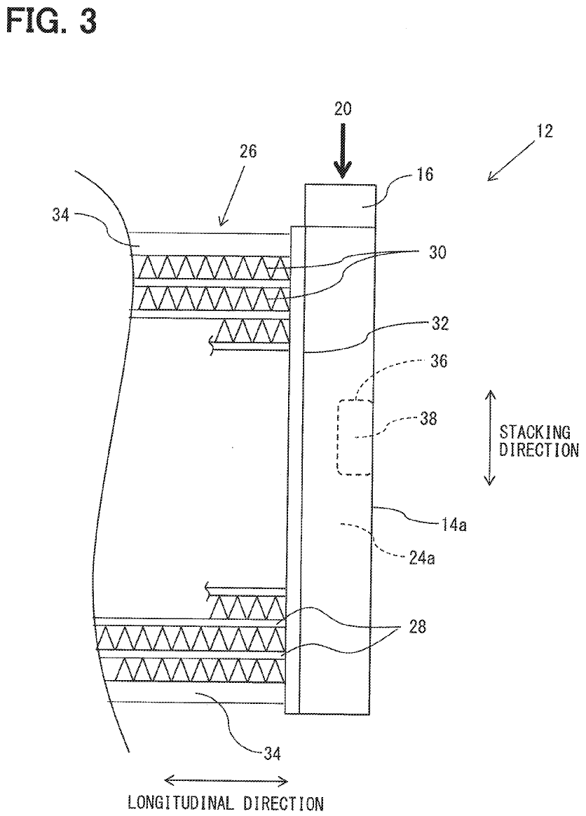

As shown in FIG. 3, a pressure adjuster 36 is positioned inside the inlet tank 14a and defines a damper chamber 38 therein. In other words, the damper chamber 38 is separately formed from the tank chamber 24a by the pressure adjuster 36. The pressure adjuster 36 is configured to be deformable to expand and reduce the damper chamber 38 according to internal pressure of the tank chamber 24a.

Specifically, in the present embodiment, the pressure adjuster 36 is formed of a flexible material such as an elastic membrane. For example, the pressure adjuster 36 may be an elastic bladder in shape. The damper chamber 38 is filled with a compressible gas such as air. The shape of the pressure adjuster 36 is not limited to the bladder shape as long as being configured to hold the compressible gas gas-tightly.

When the engine speed is high (i.e., the pump speed is high), a pressure of the fluid discharged by the pump 98 is also high. As a result, a tank pressure of the tank 14a, which is an internal pressure of the fluid in the tank chamber 24a, increases accordingly. Thus, the pressure adjuster 36 automatically reduces the damper chamber 38 by shrinking in response to the increase in the tank pressure of the tank chamber 24a.

On the other hand, when the engine speed and the pump speed are low, a pressure of the fluid discharged by the pump 98 is also low. As such, the tank pressure in the tank chamber 24a decreases accordingly. Then, the pressure adjuster 36 increases the damper chamber 38 by expanding in response to the decrease in the tank pressure in the tank chamber 24a.

The amount of expansion and contraction of the damper chamber 38, i.e., the amount of damping, can be adjustable according to the ideal gas law. In other words, the compressible gas may be chosen as needed to obtain a required amount of damping. The more the compressible gas compresses, the more the amount of damping increases. The more the amount of damping increases, the greater a reducing effect on fluctuation in the cycle pressure in the fluid circuit is. Thus, the components of the core 26 such as the tubes 28 can be protected from the fatigue.

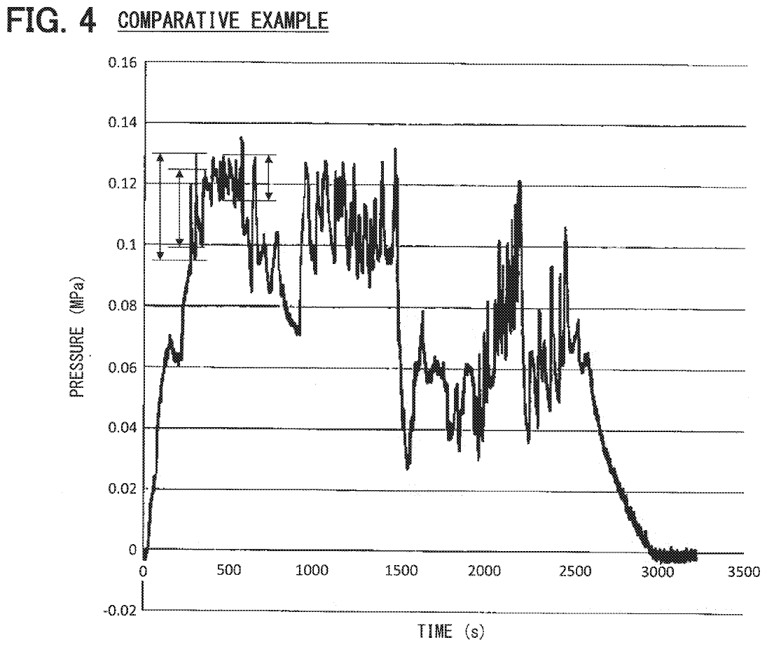

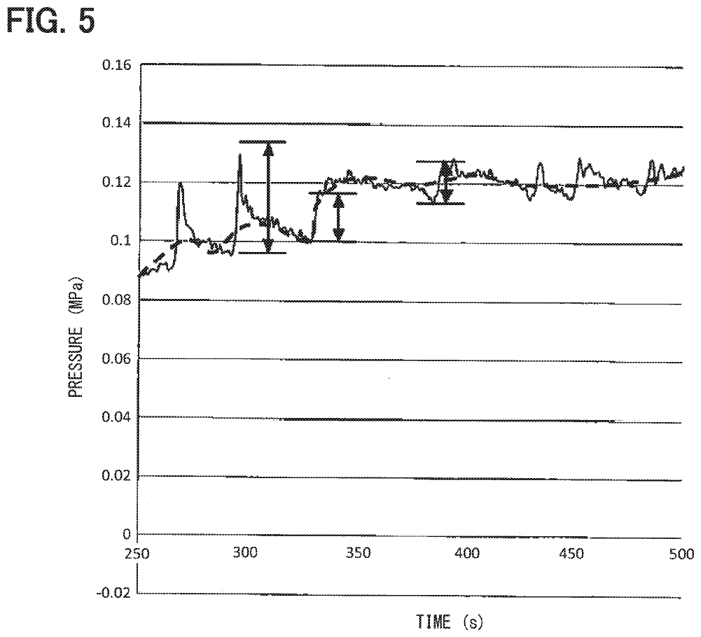

The advantages of the pressure adjuster 36 will be described in comparison with FIG. 4 and FIG. 5.

FIG. 4 shows a tank pressure profile in the inlet tank 14a of a comparative example without the pressure adjuster 36. In the comparative example, the tank pressure varies in a wide range, i.e., a range approximately from 0.001 MPa to 0.13 MPa. When the tank pressure varies in such wide range, the heat exchanger 12, i.e., the core 26, may be damaged over time.

FIG. 5 shows a tank pressure profile in the inlet tank 14a of the present embodiment with the pressure adjuster 36. In the present embodiment, the tank pressure varies in a narrower range, i.e., a range approximately from 0.09 MPa to 0.13 MPa, as compared to the comparative example.

FIG. 5 also shows a target tank pressure profile by a dashed line which is an ideal transition of the tank pressure with time. If the tank pressure of the inlet tank 14a transits along the target tank pressure profile, the fluctuation of the tank pressure would be minimized. As such, the stress caused in the core 26 can be reduced, and the fatigue of the core 26 can be minimized. As shown in FIG. 5, the tank pressure profile (the solid line) in the present embodiment matches the target tank pressure profile. Thus, fluctuation in the tank pressure can be reduced by the pressure adjuster 36 in the present embodiment. As a result, the heat exchanger 12 can be protected from fatigue over time. Therefore, a product lifetime of the components such as the tubes 28 can be extended.

The pressure adjuster 36 may be disposed in the outlet tank 14b. However, to quickly respond to fluctuation in the cycle pressure in the fluid circuit, the pressure adjuster 36 may be preferably disposed in the inlet tank 14a.

### Second Embodiment

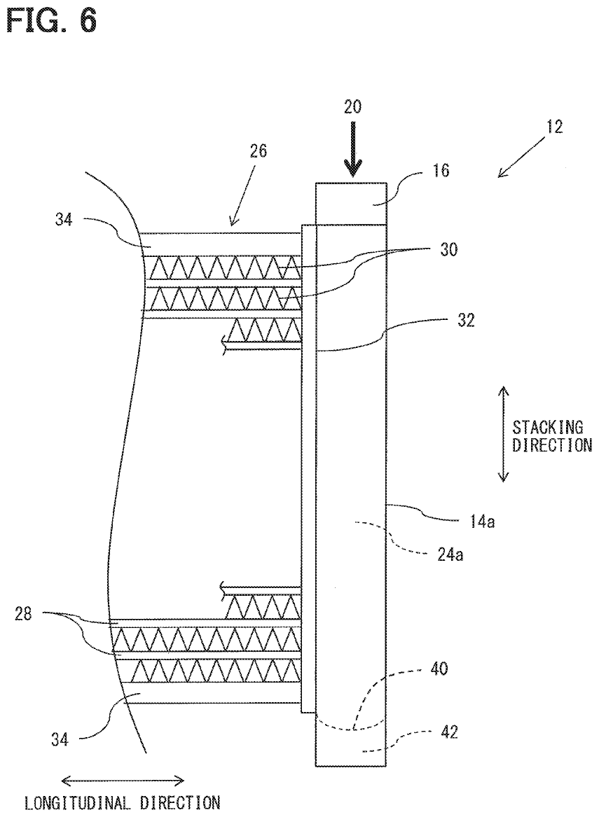

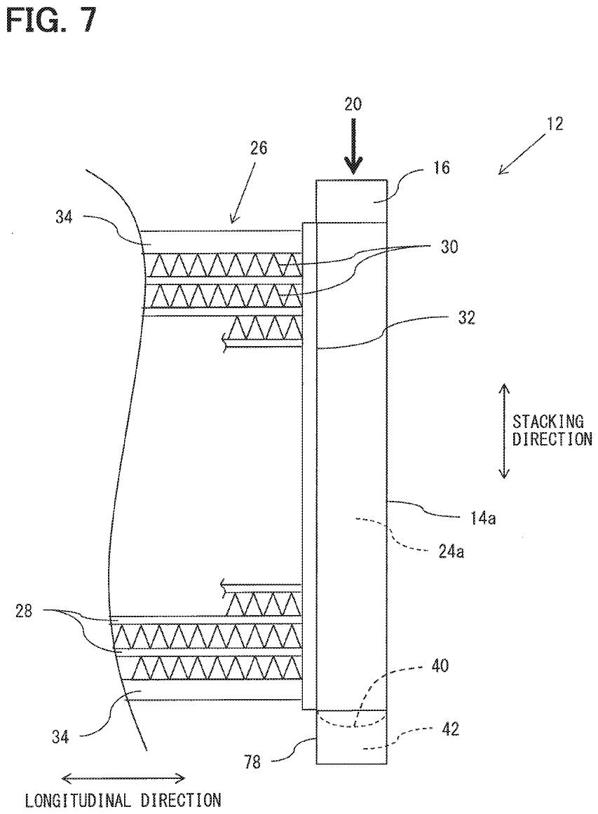

A second embodiment is described with reference to FIG. 6 and FIG. 7. The second embodiment differs from the first embodiment by the structure of the pressure damper. Parts and features in the second embodiment may have the same reference numerals as corresponding parts and features described in the first embodiment and description of such parts and features may be omitted.

In the present embodiment, a pressure adjuster 40 is positioned in the inlet tank 14a. The pressure adjuster 40 may be formed of an elastic membrane and is a sheet in shape. The pressure adjuster 40 defines a damper chamber 42 separately from the inlet tank 14a. The damper chamber 42 is filled with the compressible gas as in the first embodiment.

For example, as shown in FIG. 6, the pressure adjuster 40 may be fixed to the inlet tank 14a by a method such as adhesion to divide an inside of the inlet tank 14a into the tank chamber 24a and the damper chamber 42.

Alternatively, as shown in FIG. 7, a cup portion 78 may be attached to the inlet tank 14a with the pressure adjuster 40. In this case, the pressure adjuster 40 is interposed between the inlet tank 14a and the cup portion 78 to define the damper chamber 42 in the cup portion 78. The cup portion 78 may be made of plastic and fixed to a bottom end of the inlet tank 14a that is on a side away from the inlet port 16. The pressure adjuster 40 may be attached to a boundary between the inlet tank 14a and the cup portion 78.

The method of fixing the pressure adjuster 40 to the inlet tank 14a is not limited to adhesion as long as being configured to hold the compressible gas gas-tightly, i.e., as long as preventing the compressible gas in the damper chamber 42 from leaking to the tank chamber 24a.

By the pressure adjuster 40, the fluid in the tank chamber 24a can be prevented from entering into the damper chamber 42 and the compressible gas in the damper chamber 42 can be prevented from entering into the tank chamber 24a.

In the present embodiment, the pressure adjuster 40 serves as a diaphragm. Specifically, the pressure adjuster 40 is deformable in response to the tank pressure in the tank chamber 24a. Thus, when the tank pressure increases, the pressure adjuster 40 is deformed to reduce the damper chamber 42. On the contrary, when the tank pressure decreases, the pressure adjuster 40 is deformed to expand the damper chamber 42. Thus, the pressure adjuster 40 in the present embodiment has the same effects as the pressure adjuster 36 in the first embodiment.

### Third Embodiment

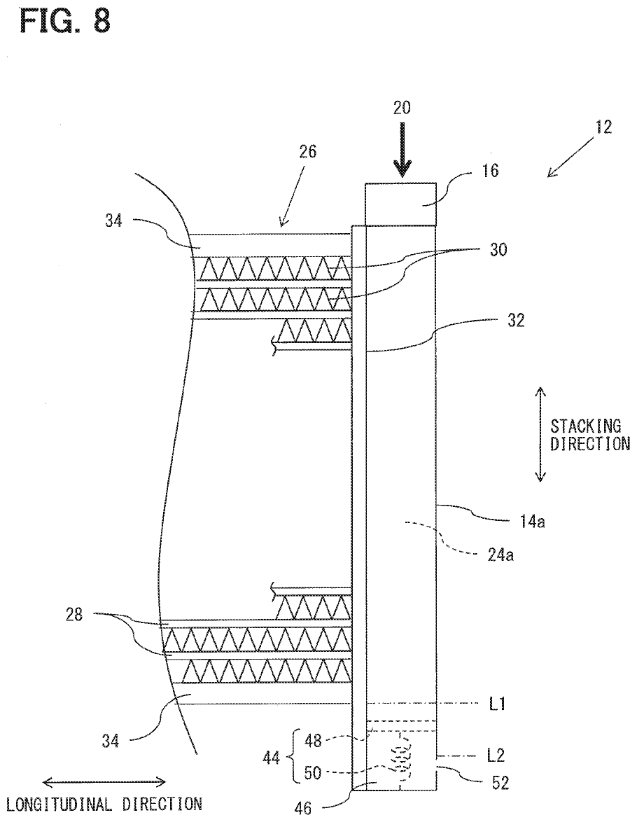

A third embodiment is described with reference to FIG. 8. The third embodiment differs from the preceding embodiments by the structure of the pressure adjuster. Parts and features in the present embodiment may have the same reference numerals as corresponding parts and features described in the preceding embodiments and a redundant description of such parts and features may be omitted.

A pressure adjuster 44 includes a plate 48 and a mechanical spring 50. The plate 48 is configured to divide the inside of the inlet tank 14a into the tank chamber 24a and a damper chamber 46. The plate 48 gas-tightly seals the tank chamber 24a from the damper chamber 46 so that the fluid in the inlet tank 14a is prevented from leaking out from the tank chamber 24a into the damper chamber 46. The damper chamber 46 is filled with the compressible gas. The mechanical spring 50 is disposed in the damper chamber 46 and attached to the plate 48 and a bottom end of the inlet tank 14.

The plate 48 is non-deformable and is configured to be displaceable to expand and reduce the damper chamber 46 in response to the tank pressure in the tank chamber 24a. Specifically, the mechanical spring 50 biases the plate 48 in a direction to expand the tank chamber 24a (the upward direction in FIG. 8). At the same time, the plate 48 receives the tank pressure from fluid in the inlet tank 14a in the opposite direction of the biasing force (the downward direction in FIG. 8). Thus, the plate 48 is positioned when the biasing force and the tank pressure balance each other.

When the tank pressure in the inlet tank 14a rises, the fluid in the inlet tank 14a presses the plate 48 against the biasing force of the mechanical spring 50 (the downward direction in FIG. 8). As such, the damper chamber 46 is reduced and allows the expansion of the tank chamber 24a.

In the present embodiment, the inlet tank 14a includes a vent 52 through which the damper chamber 46 is in fluid communication with an outside of the inlet tank 14. When the fluid in the inlet tank 14a presses the plate 48 against the mechanical spring 50 and the compressible gas is compressed to a certain extent, the compressible gas flows out of the damper chamber 46 from the vent 52. As a result, the compressible gas can be prevented from being compressed and pushing back the plate 48. Thus, the pressure adjuster 44 can reduce the damper chamber 46 sufficiently without being distracted by the compressed compressible gas.

When the damper chamber 46 is reduced, the compressible gas flows out of the damper chamber 46 through the vent 52. As such, the compressed compressible gas does not interrupt the pressure adjuster 44 when reducing the damper chamber 46. In this regard, the compressible gas may be air in the present embodiment.

While the damper chamber 46 is reduced, i.e., while the tank pressure in the inlet tank 14a rises, the plate 48 is prevented from moving across the vent 52 so that the fluid in the tank chamber 24a is prevented from flowing out from the tank chamber 24a via the vent 52. As such, a lowest level L2 for the plate 48 may be set above the vent 52.

When the tank pressure in the inlet tank 14a falls below the bias force of the mechanical spring 50, the mechanical spring 50 pushes the plate 48 in the direction to expand the damper chamber 46.

While the tank pressure in the inlet tank 14a falls and the damper chamber 46 is increased, the plate 48 is prevented from moving back across a nearest tube of the tubes 28 nearest to the pressure adjuster 44. Accordingly, none of the tubes 28 comes in fluid communication with the damper chamber 46, and thereby preventing the fluid in the tubes 28 from flowing into the damper chamber 46 at any time. As such, a highest level L1 for the plate 48 may be set below the nearest tube.

Therefore, the plate 48 moves up and down between the highest level L1 and the lowest level L2 in response to a change of the tank pressure in the inlet tank 14a. As a result, the pressure adjuster 44 absorbs the fluctuation of the tank pressure in the inlet tank 14a. As such, the pressure adjuster 44 in the present embodiment has the same effects as the pressure adjuster 36 in the first embodiment on the pressure fluctuation in the heat exchanger 12.

### Fourth Embodiment

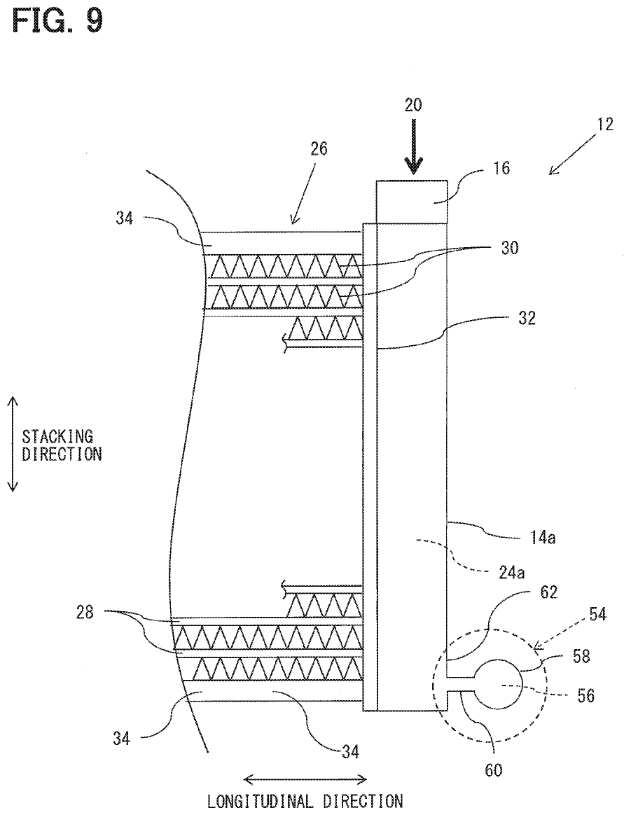

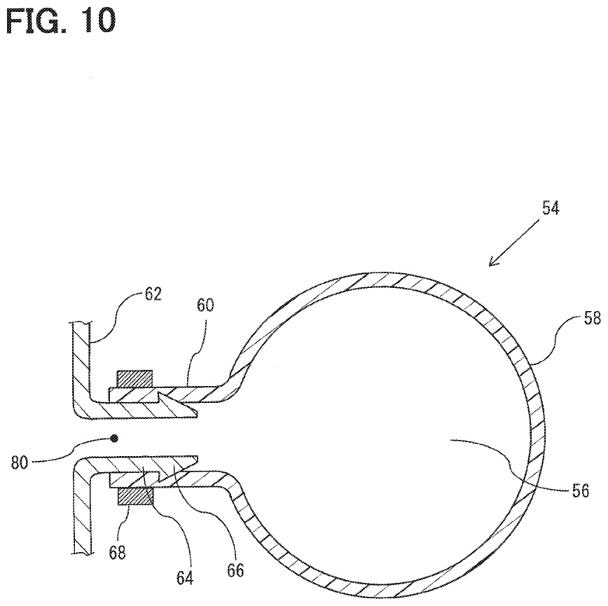

A fourth embodiment is described with reference to FIG. 9 and FIG. 10. The fourth embodiment differs from the preceding embodiments by the structure of the pressure adjuster. Parts and features in the present embodiment may have the same reference numerals as corresponding parts and features described in the preceding embodiments and a redundant description of such parts and features may be omitted.

The pressure adjusters 36, 40, 44 in the preceding embodiments are disposed inside the inlet tank 14a. In the present embodiment, a pressure adjuster 54 is attached to an outside portion of the inlet tank 14a as shown in FIG. 9. The pressure adjuster 54 is made of a flexible material such as an elastic membrane. The pressure adjuster 54 may be a bladder or a balloon in shape and defines a damper chamber 56 therein. The damper chamber 56 is in fluid communication with the tank chamber 24a.

With reference to FIG. 10, the pressure adjuster 54 includes a fluid receiving portion 58 defining the damper chamber 56 therein and a protrusion 60 protruding outward from the fluid receiving portion 58. The protrusion 60 allows the damper chamber 56 to be in communication with the tank chamber 24a. Therefore, the protrusion 60 serves as a port through which the fluid flows into and flows out of the damper chamber 56.

The inlet tank 14a includes an outer wall 62 extending along the stacking direction. The outer wall 62 may be located near the bottom end of the inlet tank 14a. The outer wall 62 includes a connection port 64 extending outward from the outer wall 62. The connection port 64 defines a through-hole 80 passing therethrough, thereby allowing the tank chamber 24a to be in communication with the outside of the inlet tank 14a. The protruding direction of the connection port 64 is not limited to the direction shown in FIG. 9.

The protrusion 60 is fitted to the connection port 64 so that the connection port 64 is inserted into the protrusion 60. Therefore, an inner diameter of the protrusion 60 may be equal to or smaller than an outer diameter of the connection port 64 so that the protrusion 60 is fitted to the connection port 64 tightly. When the connection port 64 is inserted into the protrusion 60, the tank chamber 24a and the damper chamber 56 come in communication with each other via the through hole 80 defined in the connection port 64.

The connection port 64 includes a barb 66 at an end of the connection port 64 away from the outer wall 62. The barb 66 protrudes outward from the connection port 64 along a radial direction of the connection port 64. For example, the barb 66 may have a triangle shape in cross section parallel to the protruding direction of the connection port 64. As such, when the connection port 64 is inserted into the protrusion 60, the barb 66 engages with an inner wall of the protrusion 60.

A clamp 68 is attached along an circumferential surface of the protrusion 60 between the barb 66 and the outer wall 62 of the inlet tank 14a. The clamp 68 radially inwardly presses the protrusion 60 so that the protrusion 60 is tightly clamped between the clamp 68 and the connection port 64. Thus, the protrusion 60 can be prevented from being detaching from the connection port 64.

When the tank pressure in the inlet tank 14a rises, the fluid in the tank chamber 24a flows into the damper chamber 56 through the protrusion 60. The fluid receiving portion 58 receives the fluid in the inlet tank 14a by expanding the damper chamber 56. That is, the fluid in the inlet tank 14a is allowed to flow into the damper chamber 56 in response to an increase of the tank pressure in the inlet tank 14a.

On the other hand, when the tank pressure in the inlet tank 14a falls, the damper chamber 56 allows the fluid in the damper chamber 56 to return back to the inlet tank 14a. That is, the damper chamber 56 is reduced for the decrease of the tank pressure in the inlet tank 14a.

Thus, the pressure adjuster 54 in the present embodiment has the same effects as the pressure adjusters 36, 40, 44 in the preceding embodiments on the pressure fluctuation in the heat exchanger 12.

### Fifth Embodiment

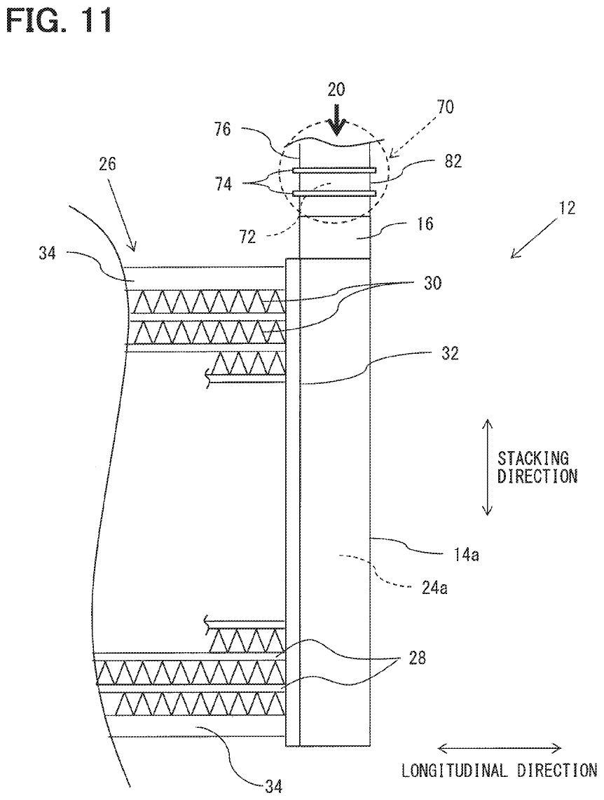

A fifth embodiment is described with reference to FIG. 11 to FIG. 13. The fifth embodiment differs from the preceding embodiments by the structure of the pressure adjuster. Parts and features in the present embodiment may have the same reference numerals as corresponding parts and features described in the preceding embodiments and a redundant description of such parts and features may be omitted.

In the present embodiment, a pressure adjuster 70 is attached to an outside portion of the inlet tank 14a as shown in FIG. 11. The pressure adjuster 70 defines a damper chamber 72 therein. The damper chamber 72 is in fluid communication with the tank chamber 24a. The pressure adjuster 70 is configured to be deformable to expand and reduce the damper chamber 72.

Specifically, the pressure adjuster 70 is formed as a part of a connection tube 76 that connects the inlet port 16 to a pipe of the fluid circuit that connects the inlet port 16 to another component of the fluid circuit. In the present embodiment, the component may be the engine 96 in the engine cooling circuit 86. The connection tube 76 and the inlet port 16 are illustrated to be arranged along the stacking direction in FIG. 11 for explanation purpose, however may be arranged along another direction such as the longitudinal direction.

The pressure adjuster 70 is formed of a flexible tube 82. The flexible tube 82 is made of a flexible material such as an elastic membrane and defines the damper chamber 72 therein. The connection tube 76 may be made of different material, e.g., a resin material, having higher stiffness than the elastic membrane. The flexible tube 82 is disposed in-line with the connection tube 76. The position of the flexible tube 82 in the connection tube 76 is not limited and may be at any positions in the connection tube 76.

Two hoops 74 are disposed to boundaries between the flexible tube 82 and the connection tube 76. The shape of each of the hoops 74 is not limited as long as connecting the connection tube 76 and the flexible tube 82 directly to each other tightly. In this regard, the hoops 74 may be clamps. When connecting the flexible tube 82 and the connection tube 76 to each other, the connecting tube 76 may be inserted into the flexible tube 82, and the hoops 74 may be fastened from the outside of the flexible tube 82. Therefore, the flexible tube 82 can be prevented from falling off the connection tube 76.

The connection tube 76 and the flexible tube 82 are in fluid communication. As such, the fluid is allowed to flow into the inlet tank 14a via the connection tube 76 and the flexible tube 82.

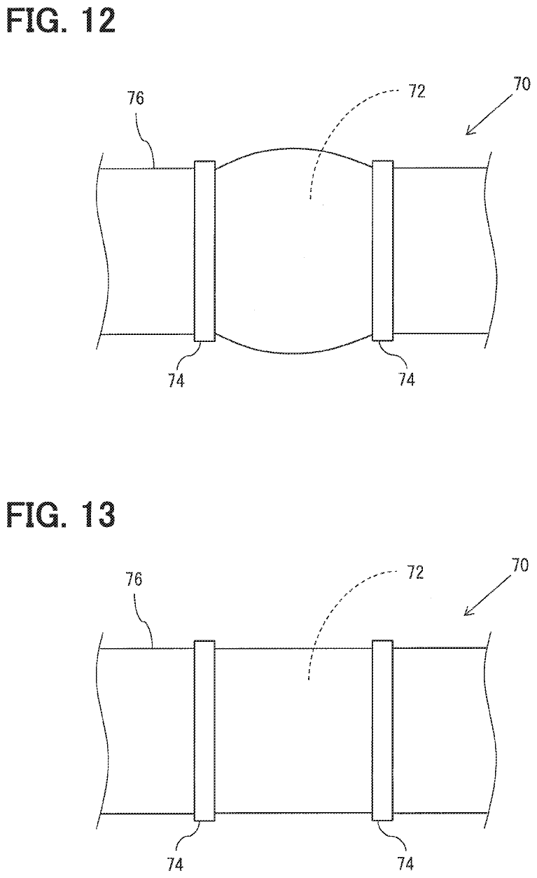

When the cycle pressure in the fluid circuit rises, a pressure of the fluid flowing through the flexible tube 82 rises. The fluid having the high pressure outwardly presses the flexible tube 82. Then, as shown in FIG. 12, the flexible tube 82 bulges to expand the damper chamber 72 in response to the increase in the pressure of the fluid flowing through the flexible tube 82. As a result, a pressure of the fluid flowing into the inlet tank 14a falls, and the pressure fluctuation in the heat exchanger 12 can be reduced.

When the cycle pressure in the fluid circuit falls, a pressure of the fluid flowing through the flexible tube 82 falls. The force of the fluid pressing the flexible tube 82 decreases as the pressure of the fluid falls. Then, the flexible tube 82 contracts to reduce the damper chamber 72 in response to the decrease in the pressure of the fluid flowing through the flexible tube 82 as shown in FIG. 13.

As such, the flexible tube 82 absorbs the increase and the decrease of the pressure of the fluid so that the pressure fluctuation in the fluid flowing into the inlet tank 14a is reduced. Therefore, the pressure fluctuation in the heat exchanger 12 can be reduced as well.

Thus, the pressure adjuster 70 in the present embodiment has the same effects as the pressure adjusters 36, 40, 44, 54 in the preceding embodiments on the pressure fluctuation in the heat exchanger 12.

### Other Embodiment

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as departure from the disclosure, and all such modifications are intended to be included within the scope of the disclosure.

Example embodiments are provided so that this disclosure will be thorough, and will convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processers, well-known device structures, and well-known technologies are not described in detail.

The technology used herein is for the purpose of describing particular example embodiments only and is not intended to be limiting. As used herein, the singular forms “a,” and “an,” and “the” may be intended to include the plural forms as well, unless the context clearly indicates otherwise. The terms “comprises,” “comprising,” “including,” and “having,” are integers, steps, operations, elements, and/or components, but do not preclude the presence or addition of one or more other features, integers, steps, operations, elements, components, and/or groups thereof.

The method steps, processers, and operations described herein are not to be construed as necessarily requiring their performance in the particular order discussed or illustrated, unless specifically identified as an order of performance. It is also to be understood that additional or alternative steps may be employed. As used herein, the terms “and/or” includes any and all combinations of one or more of the associated listed items.

What is claimed is:

1. A heat exchanger for a vehicle disposed in a fluid circuit in which a fluid is circulated according to an operating condition of the vehicle, the heat exchanger comprising:
a tank that defines a tank chamber therein and is configured to allow the fluid to flow through the tank chamber; and
a pressure adjuster that is disposed inside of the tank and defines a damper chamber separately from the tank chamber, the pressure adjuster configured to be displaceable or deformable to expand and reduce the damper chamber, wherein
the damper chamber is filled with a compressible gas,
the pressure adjuster is configured to reduce the damper chamber in response to an increase in a pressure of the fluid in the tank chamber, and
the pressure adjuster is configured to expand the damper chamber in response to a decrease in a pressure of the fluid in the tank chamber.

2. The heat exchanger according to claim 1, wherein
the pressure adjuster is an elastic bladder that defines the damper chamber therein.

3. The heat exchanger according to claim 1, wherein
the pressure adjuster is a diaphragm that is configured to divide an inside of the tank into the tank chamber and the damper chamber.

4. The heat exchanger according to claim 1, wherein
the pressure adjuster includes:
a damper chamber that is configured to divide an inside of the tank into the tank chamber and the damper chamber, and
a mechanical spring disposed in the damper chamber and attached to the damper chamber, and
the mechanical spring is configured to bias the damper chamber in a direction to expand the damper chamber.

5. A heat exchanger for a vehicle disposed in a fluid circuit in which a fluid is circulated according to an operating condition of the vehicle, the heat exchanger comprising:
a tank that defines a tank chamber therein and is configured to allow the fluid to flow through the tank chamber; and
a pressure adjuster that is disposed outside of the tank and defines a damper chamber, the damper chamber being in fluid communication with the tank chamber to receive the fluid, the pressure adjuster configured to be displaceable or deformable to expand and reduce the damper chamber, wherein
the pressure adjuster is configured to expand the damper chamber in response to an increase in a pressure of the fluid in the tank chamber, and
the pressure adjuster is configured to reduce the damper chamber in response to a decrease in a pressure of the fluid in the tank chamber.

6. The heat exchanger according to claim 5, wherein
the pressure adjuster is a flexible bladder that defines the damper chamber therein and is attached to an outside of the tank, and
the tank defines a through hole through which the damper chamber is in fluid communication with the tank chamber.

7. The heat exchanger according to claim 5, wherein
the tank is connected to a connection tube through which the fluid flows into or out of the tank chamber, and
the pressure adjuster is a flexible tube that defines the damper chamber therein and is configured to constitute a portion of the connection tube.
